(19) United States
(12) Patent Application Publication
(10) Pub. No.: US 2012/0204626 A1
(43) Pub. Date: Aug. 16, 2012

(54) SAMPLE INJECTOR FOR LIQUID CHROMATOGRAPH

(76) Inventor: Dale A. Davison, Greenwood, NE (US)

(21) Appl. No.: 13/207,124

(22) Filed: Aug. 10, 2011

Related U.S. Application Data
(60) Provisional application No. 61/373,602, filed on Aug. 13, 2010.

(51) Int. Cl. G01N 30/84

(52) U.S. Cl. 73/61.55

(57) ABSTRACT

A sample injection apparatus includes a sample container and a tube that communicates with the inlet of a liquid chromatographic column. The sample container receives at least a preparatory-sized sample. A syringe pump pulls sample from the sample container and applies it to the inlet of the liquid chromatographic column.

### RELATED CASES

This application is a continuation of U.S. provisional application 61/373,602 filed Aug. 13, 2010, by inventor, Dale A. Davison. The benefit of provisional patent application 61/373,602 is claimed.

### BACKGROUND OF THE INVENTION

This invention relates to sample injection into liquid chromatographs.

It is known to transfer large samples in preparatory liquid chromatography from a flask or other container into a liquid chromatographic column for preparatory liquid chromatography. One prior art method of transferring the sample to the column is to prepare the sample in a flask or other container and then pipette the sample into the column. The method is slow and under some circumstances fails to transfer the entire sample. Instead, some of the sample remains in the flask because it is difficult to get it into the pipette. In another prior art method, the sample is pumped from a container near the column through tubing inserted into the open top of the container and then into the top of the column. This prior art system also has the disadvantages of being difficult and slow failing to transfer the entire sample to the column.

### SUMMARY OF THE INVENTION

Accordingly, it is an object of the invention to provide novel sample injection methods and apparatuses.

It is a further object of the invention to provide novel methods and apparatuses for injecting sample into a chromatographic column from a container with less sample left remaining in the container after the transfer than occur with prior art methods and apparatuses.

It is a still further object of the invention to provide a system for shortening the time for sample application in preparatory chromatography.

It is a still further object of the invention to provide a novel sample injection method and apparatuses which reduce the circumstances under which an undesirable amount of sample fails to get injected.

In accordance with the above and further objects of the invention, a sample injection system includes a sample container large enough to contain a preparatory sample. In a first embodiment, the container is directly connected to a sample injection pump or to the inlet of a column. In some versions of this embodiment, a filter is incorporated. In a second embodiment, a suction pump is directly connected to the top of the column or to an injection valve for application of a preparatory sample. The pump is connected by a conduit to a flask in which the sample is prepared so as to utilize suction to move the prepared sample into the column. In operation, sample is prepared and poured into a funnel like container or may be prepared in the funnel like container. This container is mounted directly above and in communication with an injection pump that pumps sample from the container either directly into the top of the column or into an injection valve for application into the top of the column. Alternatively, the flask may be separate and a suction pump may pull sample from the flask into the barrel into the pump and from there directly into either the top of the column or an injection valve.

To inject a preparatory-sized into a liquid chromatographic column, a preparatory-sized sample is transferred from a sample container to the chromatographic column through a tube shaped and sized to communicate with the top of the liquid chromatographic column. The mobile phase eluent is supplied to the column to obtain eluate at the column outlet. In the alternative, the preparatory sized sample is drawn through a tubular connector from the sample container into a syringe and injected into the column with the syringe.

In each of the above alternatives, the solvent is injected into the column through a straight path through said valve into the column, whereby blockage of the valve by sample is avoided. The valve element is rotated in the valve and includes a straight smooth passageway through the valve until an end of the smooth straight passageway is in communication with a sample cartridge and the other end is in communication with the column. In one embodiment, the sample is obtained in a container and poured into another container directly connected to the inlet of a piston pump. The sample is pumped from the container into the column. The sample may be poured from a flask into a container that is directly above the pump inlet or the sample may be poured into a syringe barrel. In one embodiment, the sample is injected by either of the above methods into a sample holder and solvent is applied through said sample holder and through a valve into a column, whereby the sample is injected into said column;

From the above summary of the invention it can be understood that these methods of injecting a sample into a liquid chromatographic column have several advantages such as: (1) it avoids reduction in the amount of solvent transferred into the column due to the sample remaining in the sample container; (2) they transfer more of the sample to the column; (3) they are relatively fast compared to pipetting the sample into the sample injector or pumping the sample into the sample injector; and (4) they are relatively easy to do.

From the above description it can be understood that the apparatuses and methods of this invention have several advantages such as: (1) it is a quick and fast technique for injecting sample; and (2) it provides a more complete and better yield of sample from the flask in which the sample is prepared to the column.

In the specification the term, “a preparatory-sized sample”, means the sample size used for preparatory liquid chromatography. The amount of sample injected for a run will vary with the material to be separated. In this specification the amount of sample is related to the size of the sample needed and the size of the sample injection valve available and useful for the separation.

### BRIEF DESCRIPTION OF THE DRAWINGS

The above and other objects of the invention will be better understood from the following detailed description when considered together with the accompanying drawings in which:

FIG. 1 is a simplified block diagram of an embodiment of the invention;

FIG. 2 is a simplified perspective view of a portion of an embodiment of the invention;

FIG. 3 is a block diagram of another embodiment of the invention;

FIG. 4 is a fragmentary perspective view of the second embodiment of the invention;

FIG. 5 is a simplified block diagram of a liquid chromatographic system utilizing an embodiment of the invention.

FIG. 6 is a simplified block diagram of another liquid chromatographic system utilizing an embodiment of the invention.

### DETAILED DESCRIPTION

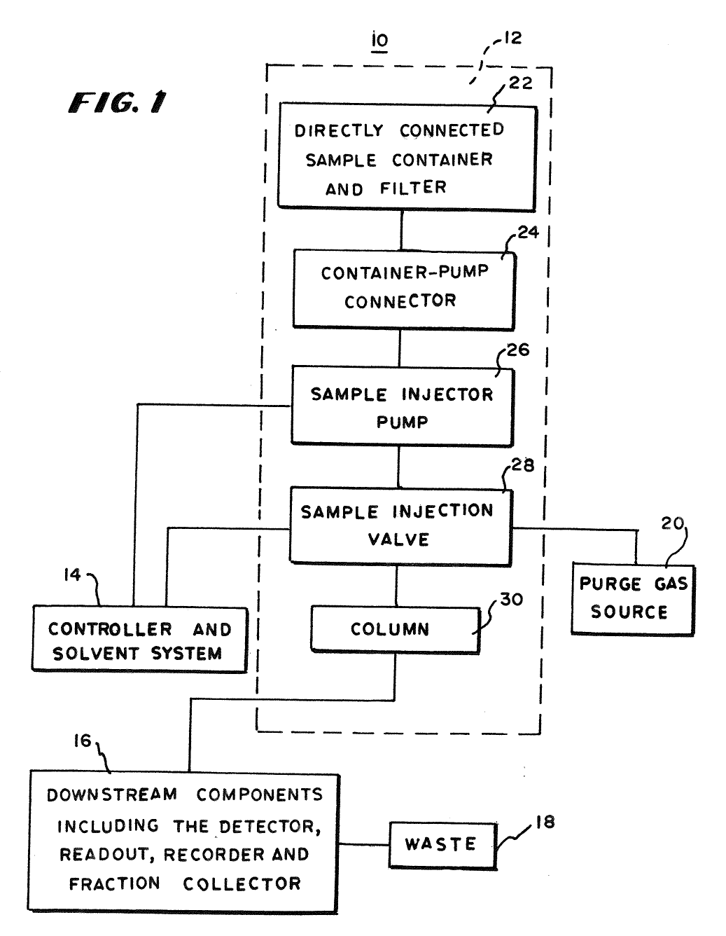

In FIG. 1 there is shown a preparatory liquid chromatographic system 10 having a controller and solvent system 14, a column and sample injection system 12, downstream components including the detector, readout recorder and fraction collector 16, waste collection apparatus 18 and a purge gas source 20. The column and sample injection system 12 includes a directly connected sample container 22, a container-pump connector 24, a sample injection pump 26, a sample injection valve 28 and the column 30. The directly connected sample container 22 communicates through a container-pump connector 24 with the inlet of a column 30 either directly or through a sample injection valve 28. If a sample injection valve is included rather than a direct connection to the inlet of a column, the inlet of the column communicates with one port of the sample injection valve, the solvent system with another, a waste system with still another and a purge gas source with still another. A valve connected in his manner for preparatory chromatography is described in U.S. patent application Ser. No. 11/698,368, the disclosure of which is incorporated herein by reference.

The directly connected sample container may include at its outlet a filter for removing undissolved sample.

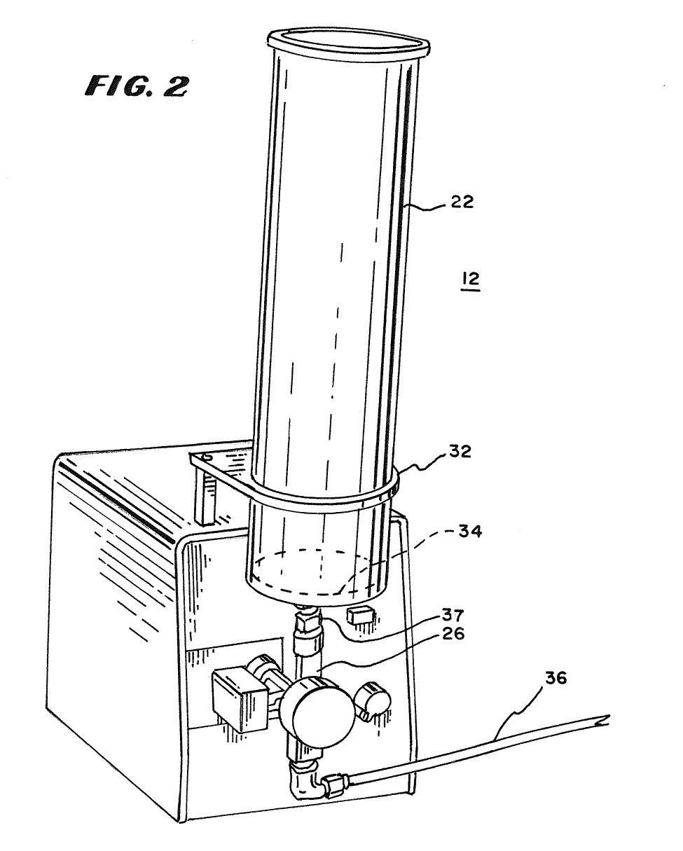

In FIG. 2, there is shown a fragmentary perspective view of the sample injector and column system 12 having one embodiment of directly connected sample container 22 mounted to an attachment fixture 32 to the casing 34. A filter 34 is positioned at the bottom of the container 22 which may be shaped as a syringe barrel and communicate at its lower end through a luer to an input 36 to a pump 26, a waste outlet 36 communicates with a waste container or disposal means and is connected to the outlet. Other downstream elements such as the sensor communicate with a window (not shown in FIG. 2) and positioned internally to the cabinet 26 along with the detector readout recorder and the like as well as with the fraction collector.

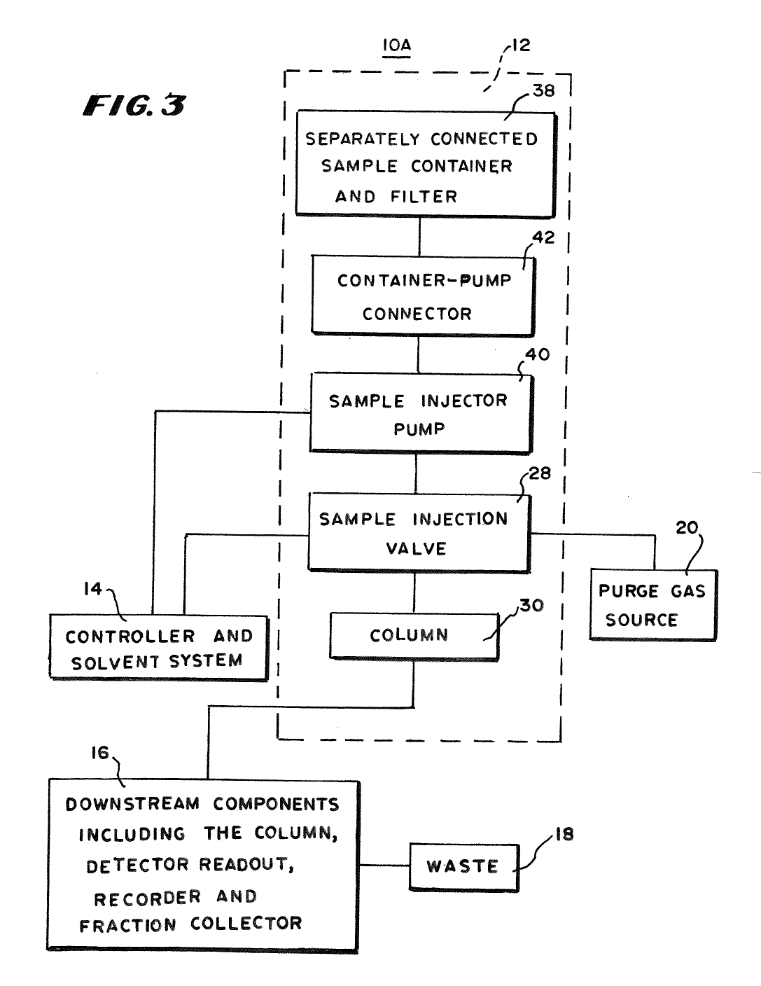

In FIG. 3, there is shown a block diagram of another embodiment of preparatory liquid chromatographic system 10A having a separately connected sample container and filter 38 communicating with the sample injector pump 40 through a suction tube so that the suction pump 40 pulls sample through a filter and from the container 38 and injects it into the column either directly at the top of the column or through a sample injection valve. In this embodiment, the controller and solvent system, downstream components director readout recorder and fraction collector 16, waste connection 18 and purged gas source 20 are the same as in the embodiment of FIG. 1 and contain the same reference numbers.

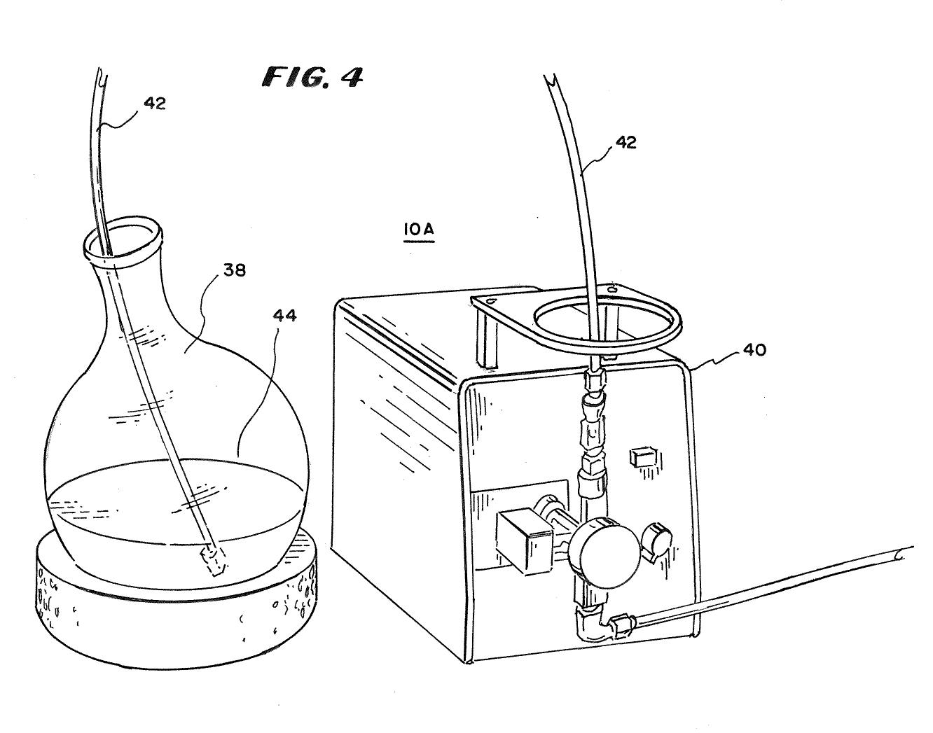

In FIG. 4, there is shown a fragmentary perspective view of the chromatographic system 10A having a sample container and filter 38 with the filter 44 being formed around the connecting tube 42 leading to the pump 40. The pump 40 may be connected to syringe pump 40 which injects the sample either into the sample injection valve 28 or directly into the top of the column 30.

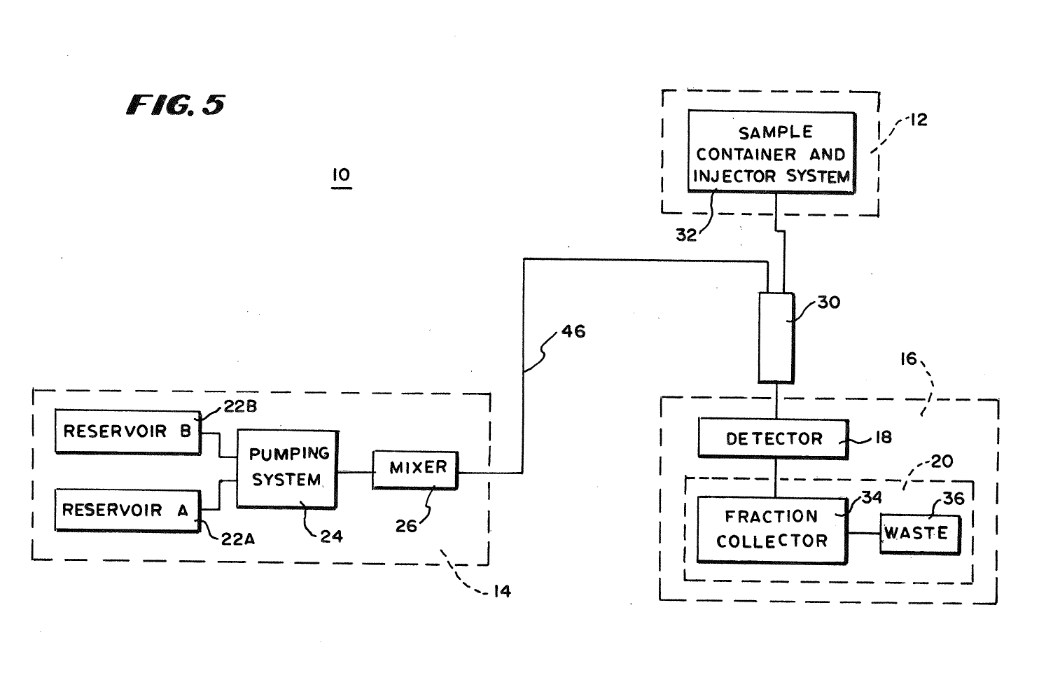

In FIG. 5, there is shown a block diagram of the chromatographic system 10 having the column and sample injection system 12, the controller and solvent system 14, the downstream components including the detector, readout, recorder and fraction collector 16 and the column 30. In this embodiment, the sample container and injector system 12 includes the container 22 that has the sample in it and the syringe pump or other injecting mechanism that injects the sample either into the top of the column 30 or into an injection valve. The controller and solvent system includes a controller (not shown in FIG. 5) reservoirs 22A and 22B being shown by example including the solvents that are mixed to provide the desirable gradient, the pumping system 24 and the mixer 26 that applies a solvent mixture to the column 30 through a conduit 46 to move the sample through the packing of the chromatographic column 30 for separation or purification. The detector 18 may be incorporated to detect the existence of the sample and a fraction collector 34 under the control of the controller may collect the sample in one or more sample containers. The fraction collector may be connected to the pumping system and control at 24 wirelessly or through direct wiring (not shown in FIG. 5).

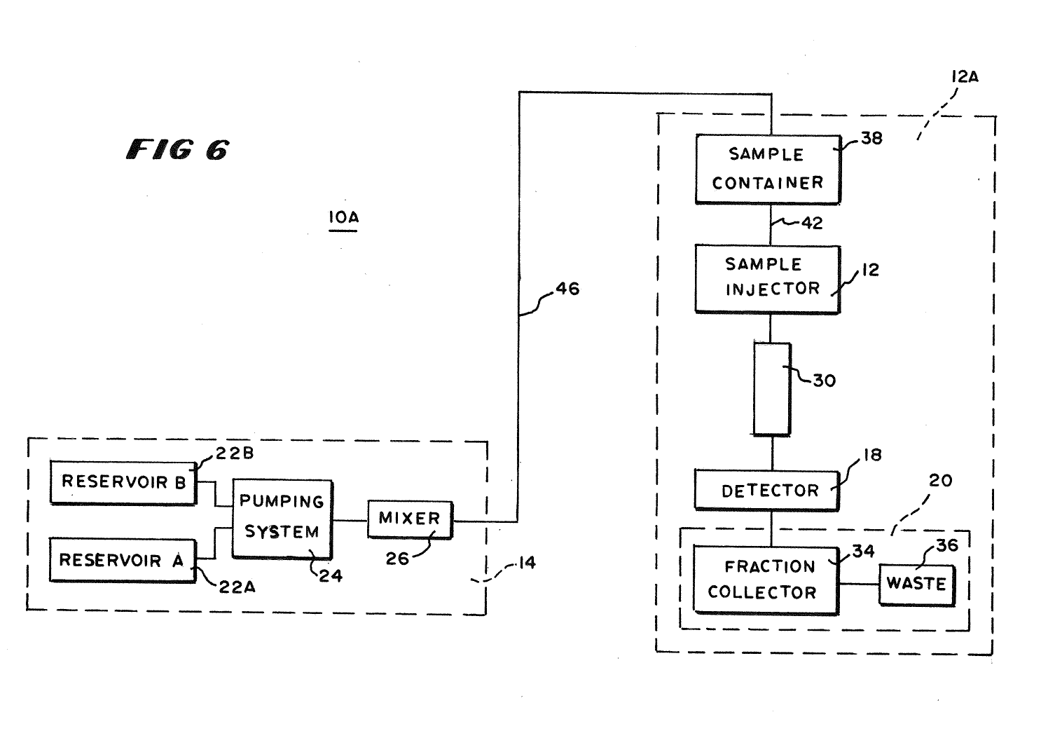

In FIG. 6, there is shown another embodiment of a liquid chromatographic system 10A having the column and sample injector system 12A, the controller and solvent system 14, the column 30, and the downstream element 16. The solvent system 14 and downstream element 16 and column 30 are identical to the embodiment of FIG. 5. However, the column and sample injection system 12 includes a sample container 38 connected by a conduit 42 to the injection system to supply directly sample through a suction pump injection system either into the top of the column or into an injection valve.

Although a preferred embodiment of the invention has been described with some particularity, many modifications and variations are possible within the light of the above teachings. Therefore, it is to be understood that, within the scope of the appended claims, the invention may be practiced other than as specifically described.

What is claimed:

1. Sample injection apparatus comprising:
a sample container;
said sample container containing a communication tube shaped and sized to communicate with the inlet of a liquid chromatographic column; and
said sample container being sized and shaped to receive at least a preparatory-sized sample.

2. Sample injection apparatus comprising:
a sample container;
a syringe pump;
a tubular connector;
said tubular connector communicating between the syringe pump and sample container wherein the syringe pump pulls sample from the sample container;
a liquid chromatographic column;
said syringe pump being in communication with the input to the liquid chromatographic column wherein the syringe pump may apply sample to the inlet of the liquid chromatographic column;
said sample container containing a communication tube shaped and sized to communicate with the top of a liquid chromatographic column; and
said sample container being sized and shaped to receive an adequate sample for preparatory chromatography.

3. A method of injecting a preparatory-sized sample into a liquid chromatographic column, comprising the steps of:
obtaining a sample container with a preparatory-sized sample in the sample container, wherein the sample container contains a communication tube shaped and sized to communicate with the top of a liquid chromatographic column;
supplying the preparatory-sized sample to the column; and
supplying a mobile phase eluent to the column to obtain a eluate at the column outlet.

4. A method of injecting a preparatory sized sample into a liquid chromatographic column, comprising the steps of:
obtaining a sample container with a preparatory-sized sample in the sample container, drawing the preparatory sized sample through a tubular connector from the sample container into a syringe and injecting the preparatory sized sample into the column with the syringe; into the column;
the step of applying said solvent into said sample holder including the step of applying solvent through a straight path through said valve into the column, whereby blockage of the valve by sample is avoided;
of rotating a valve element in the valve having a straight smooth passageway through it until an end of the smooth straight passageway is in communication with a sample cartridge and the other end is in communication with the column;
pouring the sample into a container directly connected to the inlet of a piston pump; and
pumping the sample from the container into the column.

5. A method in accordance with claim 7 wherein the sample is poured from a flask into a container above the pump inlet.

6. A method in accordance with claim 7 wherein the sample is poured into a syringe barrel.

7. A method of performing preparatory chromatography comprising placing a preparatory-sized sample in a sample holder;
applying solvent through said sample holder and through a valve into a column, whereby said sample is injected into said column; and
the step of applying said solvent into said sample holder including the step of applying solvent through a straight path through said valve into the column, whereby blockage of the valve by sample is avoided.

8. A method of performing preparatory chromatography in accordance with claim 5 in which the step of applying solvent through said sample holder and through a valve into a column, includes the substep of rotating a valve element in the valve having a straight smooth passageway through it until an end of the smooth straight passageway is in communication with a sample cartridge and the other end is in communication with the column.

9. A method of introducing sample into a preparatory liquid chromatographic column, comprising the steps of:
obtaining the sample;
pouring the sample into a container directly connected to the inlet of a piston pump; and
pumping the sample from the container into the column.
